(19) United States
(12) Patent Application Publication
(10) Pub. No.: US 2013/0238623 A1
(43) Pub. Date: Sep. 12, 2013

(54) Method of Linking Electronic Database Records

(71) Applicants: David Wyllie, Headington (GB); John Michael Finney, Headington (GB)

(72) Inventors: David Wyllie, Headington (GB); John Michael Finney, Headington (GB)

(73) Assignee: IsIs Innovation Limited, Oxford Oxfordshire (GB)

(21) Appl. No.: 13/577,195

(22) PCT Filed: Feb. 3, 2011
(86) PCT No.: PCT/GB2011/000145

§ 371 Date: May 28, 2013

(30) Foreign Application Priority Data
Feb. 4, 2010 (GB) 100859.6

(51) Int. Cl. G06F 17/30

(52) U.S. Cl. CPC G06F 17/30598
USPC 707/737

(57) ABSTRACT

A method of linking electronic database records, wherein each record is associated with a single member from a set of unique members, and wherein each member from the set of unique members has associated with it a plurality of identifiers for uniquely identifying the member. The method comprising the following steps. First, a set of combinations of identifiers is obtained by, for each record, determining a plurality of identifiers using the data stored in the record. Next, a set of clusters of linked combinations of identifiers is created, by creating a link between any combinations that have equal identifiers. For each cluster from the set of clusters, a quality value for the cluster is calculated, and any cluster whose quality value is below a pre-determined threshold is split into two or more clusters by removing one or more links between combinations in the original cluster, if in that case the resulting clusters have higher quality values than the original cluster. Finally, any records whose corresponding combinations of identifiers are members of the same cluster are linked.

### BACKGROUND OF THE INVENTION

The present invention concerns a method of linking records from one or more electronic databases. In particular, the invention concerns the linking of records which are associated with the same member from a set of unique members.

It is often desirable to link the records in one or more databases which are associated with the same member from a set of unique members. For example, in a database of hospital test results, the patients who underwent the tests will be the unique members. The database may contain multiple records for each patient, corresponding to different tests performed upon the same patient. Each record may contain a number of pieces of data that are intended to help identify the patient, for example their surname, initials, date of birth, patient number assigned by the hospital, and/or NHS number. (The NHS or National Health Service number is a number assigned by the UK government to an individual to identify them for healthcare purposes.) There may be multiple databases of such records, with records in more than one of the databases containing records for the same patient.

For a number of reasons, it may not be easy to identify which records correspond to the same patient using the data in the record. There may be errors in the data; for example the patient's surname may be spelled incorrectly, or their date of birth, patient number or NHS number recorded incorrectly. The data associated with a patient may also change over time, for example due to a name change following marriage, or a new hospital number being given to the patient on a subsequent visit to the hospital.

Consequently, linking records by simple matching of corresponding data in the records may not be reliable. Records may be erroneously linked, for example if there is a mistake in the NHS number recorded for a patient, and the number recorded in fact belongs to another patient. Similarly, records that should be linked may erroneously be considered to be separate, for example records may not be linked for a patient before and after they have changed their name.

A number of methods of linking records that attempt to overcome the above-mentioned problems are known. Winkler, W. E., Overview of Record Linkage and Current Research Directions. 2006, Statistical Research Division, U.S. Census Bureau. p. 44. gives an overview of known methods. Known methods broadly fall into three categories.

In the first category are probabilistic methods. These calculate a likelihood that two records are associated. A problem with these types of methods is that it can be difficult (or impossible) to provide an algorithm that is satisfactory across all cases. Further, for any particular algorithm it can be difficult to select a suitable likelihood threshold to use when deciding, whether two records are indeed associated.

In the second category are rule-based methods. These use a set of rules to decide whether two records are associated, based on the data they contain. For example, a rule set might associate all records with the same name, date of birth and social security number, on the basis that they represented the same person. A problem with these types of methods is that the rule set to be used can be very complex, and may be difficult to maintain (the results may depend on rule order for example). Further, rule sets may not work satisfactorily (or at all) when applied to records from different databases.

A problem with both probabilistic methods and rule-based methods is that they do not scale well; if n records are to be merged then n(n−1)/2 comparisons are required, which can take an unacceptable amount of time for large values of n. One proposed solution involves dividing the database into discrete segments (blocks) with much smaller n, and performing computation on each of these separately. However, such methods may still take an unacceptable amount of time, or alternatively may fail to associate records satisfactorily.

In the third category, which has become popular more recently, are graph-based methods. These treat records as nodes in a graph, with edges between the nodes representing a link of some kind between the corresponding records. The graph is then analysed and manipulated (for example edges may be added or deleted). Ideally the graph that results should link only nodes that correspond to associated records; these linked nodes are known as “clusters”. Various clustering algorithms are known, but they suffer from various problems such as not scaling well to large numbers of records, or being inaccurate (i.e. linking records that should not be linked and/or not linking those that should).

McCallum, A., K. Nigam, and L. H. Ungar, Efficient Clustering of High Dimensional Data Sets with Application to Reference Matching, in Proceedings of the sixth ACM SIGKDD international conference on Knowledge discovery and data mining. 2000, ACM: New York. describes a method in which the nodes are put into “canopies”. The canopies are large overlapping sets of nodes, and the categorisation into categories is done by means of a computationally cheap but very imprecise algorithm. The nodes inside each canopy are then linked using a precise but computationally expensive clustering algorithm. This allows more precise clustering algorithms to be used on large sets of records in a reduced time. This approach is somewhat similar conceptually to the blocking strategies used for analysis with probabilistic methods.

Sauleau, E. A., J. P. Paumier, and A. Buemi, Medical record linkage in health information systems by approximate string matching and clustering. BMC Med Inform Decis Mak, 2005. 5: p. 32. describes a method in which nodes are again put into large canopies. Weighted edges are then created between the nodes in a canopy by calculating a probability value that the underlying records are associated. Edges are then removed if their weighting falls below a threshold, and a known clustering algorithm is then applied to the nodes and remaining edges.

The known methods of linking records can be slow, may not scale well to large numbers of records, or can be inaccurate. Another problem with known methods is that they may not be suitable to be used when adding new records to a set of records that have already been linked, because of the time taken to determine the linking of the new record.

The present invention seeks to provide an improved method of linking records that mitigates the above-mentioned problems. Alternatively or additionally, the present invention seeks to provide a method of linking a new record to a set of existing linked records. Alternatively or additionally, the present invention seeks to provide a method of identifying data in records which is likely to contain errors.

While the above background of the invention has been described mainly with reference to databases of healthcare records, the invention applies equally to any databases where each record is associated with a particular individual, or indeed any single member from a set of unique members. For example, the invention could be applied to databases of tax records, employment records, or the like. As another example, the invention could be applied to databases of patent applications, to identify the records that correspond to application in the same patent family. As a final example, the invention could be applied to databases of goods for sale (i.e. catalogues), to identify goods that are duplicated in a catalogue, or to combine catalogues from two or more companies.

### SUMMARY OF THE INVENTION

In accordance with a first aspect of the present invention there is provided a method of linking electronic database records, wherein each record is associated with a single member from a set of unique members, and wherein each member from the set of unique members has associated with it a plurality of identifiers for uniquely identifying the member, the method comprising the steps of:

1) obtaining a set of combinations of identifiers by, for each record, determining a plurality of identifiers using the data stored in the record;

2) creating a set of clusters of linked combinations of identifiers, by creating a link between any combinations that have equal identifiers;

3) for each cluster from the set of clusters, calculating a quality value for the cluster;

4) for any cluster whose quality value is below a pre-determined threshold, splitting the cluster into two or more clusters by removing one or more links between combinations in the original cluster, in the case that the resulting clusters have higher quality values than the original cluster;

5) linking any records whose corresponding combinations of identifiers are members of the same cluster.

This provides an advantageous method for determining the records in databases that are associated with a unique member of a set, for example an individual from a database of records of records about a group of people. The invention applies equally to records from a single database or from a plurality of different databases. The databases need not be structured similarly, but only need to refer to members of the same set. From each record, a plurality of identifiers are obtained, each of which should be expected to uniquely identify a member. The combinations are then put into clusters, which are analysed to decide if they should be split into smaller, separate clusters. Any records whose corresponding combinations are in the same resulting clusters are considered to be associated with the same member, and so are linked. The method will, of course, be computer-implemented.

The method of this aspect of the invention uses a simple, cheap method to create the links between the records (in fact between the combinations of identifiers that represent the records)—simply creating a link if there is equality of identifiers. The records are then put into clusters, which due to the simple nature of the link creation are likely to contain records that are not in fact associated. The clusters are then analysed, and split if required so that (ideally) non-associated records are in separate clusters. This is in particular in contrast to the method of Sauleau et al described above, where the records are linked using a sophisticated, expensive similarity function. The result of the known clustering algorithm is then the final output of the method, and no analysis of the clusters is performed.

Preferably, the method further comprises the following step performed before step 1:
0a) putting the data in the records in a canonical form.

More sophisticated initial “cleaning” of the data may also be performed, for example analysing surnames and forenames of individuals to decide if they are likely to have been inverted.

The method may further comprise the following step performed before step 1:
0b) determining, from the fields of the database records, the categories of identifiers to be used to uniquely identify the members from the set of unique members.

This step will likely be done by a human operator, who considers the fields of the database or databases to determine which fields or combinations of fields should be used. However, a computer-implemented method of determining the categories of identifiers by analysing the database or databases would not be outside the scope of the invention.

Preferably, step 1 of the method further comprises the substep:
1a) obtaining a set of unique combinations of identifiers by removing any duplicates from the set of combinations obtained from the records.

This makes the later steps of the method much more efficient, as there are fewer combinations and fewer links between them to be considered.

Step 3 of the method may comprises the following substeps:
3a) calculating a similarity value for corresponding identifiers from pairs of combinations in the cluster;
3b) using the similarly values for each identifier to calculate the quality value for the cluster.

Alternatively, step 3 of the method may comprises the following substeps:
3a) calculating a similarity value for corresponding fields from pairs of records from which the combinations in the cluster were obtained;
3b) using the similarly values for each field to calculate the quality value for the cluster.

The skilled person will appreciate that there are various functions that can be used to calculate the similarity value for the identifiers or the corresponding fields, for example the Levenshtien edit distance, Jaro-Winkler string similarity function, a count of distinct identifiers, or some other function. The output from these functions, computed from the contents of the entire cluster, can then be processed in order to classify clusters using well-known statistical and computer science techniques, such as naïve Bayesian classification, support vector machines, principal components analysis, neural networks or the like. However, the skilled person will appreciate that the calculation of similarity values for the identifiers or the corresponding fields is not essential for the present invention, and any suitable method of obtaining a quality value for the cluster would suffice.

Preferably, in step 4 of the method a cluster is split into two clusters by removing an identifier from one of the combinations of identifiers and any links created due to that identifier. Alternatively, in step 4 of the method a cluster is split into two clusters by removing a single link between two combinations in the original cluster.

Alternatively, any links between two combinations in the original cluster may be removed, or two or more links between more than two combinations in the original cluster may be removed. The skilled person will appreciate that there are various different methods of splitting clusters that suffice for the present invention.

Preferably, steps 3 and 4 of the method are repeatedly performed on any resulting clusters until all remaining clusters have a quality value below the pre-determined threshold.

Alternatively, the method may be repeated only a pre-determined number of times, or until the remaining clusters satisfy some requirement (for example a requirement based on sizes).

Advantageously, the database records are obtained from two or more separate electronic databases. However, the invention is equally applicable to single databases with multiple records associated with a unique member of a set.

In accordance with a second aspect of the present invention there is provided a method of linking a new electronic database record to existing records linked by a method as described above, comprising the steps of:
1) obtaining the combination of identifiers for the new record;
2) creating a link between the new combination and any combinations that have equal identifiers from the set of clusters created when linking the existing records;
3) calculating a quality value for the cluster containing the new combination;
4) if the quality value of the cluster is below the pre-determined threshold, splitting the cluster into two or more clusters by removing one or more links between combinations in the original cluster, in the case that the resulting clusters have higher quality values than the original cluster;
5) linking the new record to any record whose corresponding combination of identifiers is a member of the same cluster as the new combination.

This provides an advantageous method of linking a new record to a set of records that have already been linked. As only the cluster containing the combination obtained from the new record needs to be considered (rather than the new record having to be compared against all existing records, for example), the method is very fast and can be used to link records in real time (in other words as they are entered into the database).

Preferably, the method further comprises the following step performed before step 1:
0a) putting the data in the new record in a canonical form.

Preferably, steps 3 and 4 of the method are repeatedly performed on any resulting clusters until all remaining clusters have a quality value below the pre-determined threshold.

Advantageously, the method further comprising the following steps performed after step 1:
1a) if the new combination is already present in the set of combinations of identifiers obtained when linking the existing records, linking the new record to any record whose corresponding combination of identifiers is a member of the same cluster as the new combination, and not performing any of the remaining steps.

If the combination obtained from the new record already exists, the record can simply be linked to records with that combination or combinations linked to that combination.

In accordance with a third aspect of the present invention, there is provided a method of identifying data that is likely to contain errors, in electronic database records linked by a method as claimed in any of claims 1 to 13, comprising the steps of:
1) for any cluster split into two or more clusters by removing one or more links, determining the identifiers linked by the removed links;
2) determining the data of the records underlying the identifiers determined in step 1;
wherein the identified data is the data determined in step 2.

Clusters are split in the case that the resulting clusters have a higher quality value than the original cluster. A higher quality value is intended to indicate that a cluster is more likely to contain only records associated with a single member, and so this indicates that a removed link will have linked equal identifiers in records that were in fact associated with different members. As the identifiers are intended to uniquely identify the members, this suggests that the data from at least one of the records that underlay the identifiers must contain errors.

In accordance with a fourth aspect of the present invention, there is provided a computer program product arranged, when executed, to perform the steps of a method as described above.

### DESCRIPTION OF THE DRAWINGS

Embodiments of the present invention will now be described by way of example only with reference to the accompanying schematic drawings of which:

FIG. 1 shows an excerpt of an electronic database of healthcare records;

FIG. 2 shows a cleaned version of the excerpt of FIG. 1, in accordance with a first embodiment of the present invention;

FIG. 3 shows a set of combinations of identifiers obtained from the cleaned excerpt of FIG. 2;

FIG. 4 shows a set of unique combinations obtained from set of combinations of FIG. 3;

FIG. 5 shows a cluster of combinations obtained from the set of unique combinations of FIG. 4;

FIG. 6 shows two clusters of combinations obtained from the cluster of combinations of FIG. 5;

FIG. 7 shows a new record to be linked to the records of FIG. 1;

FIG. 8 shows a cleaned version of the record of FIG. 7;

FIG. 9 shows a combination obtained from the cleaned record of FIG. 8;

FIG. 10 shows the combination of FIG. 9 added to the clusters of FIG. 6.

### DETAILED DESCRIPTION

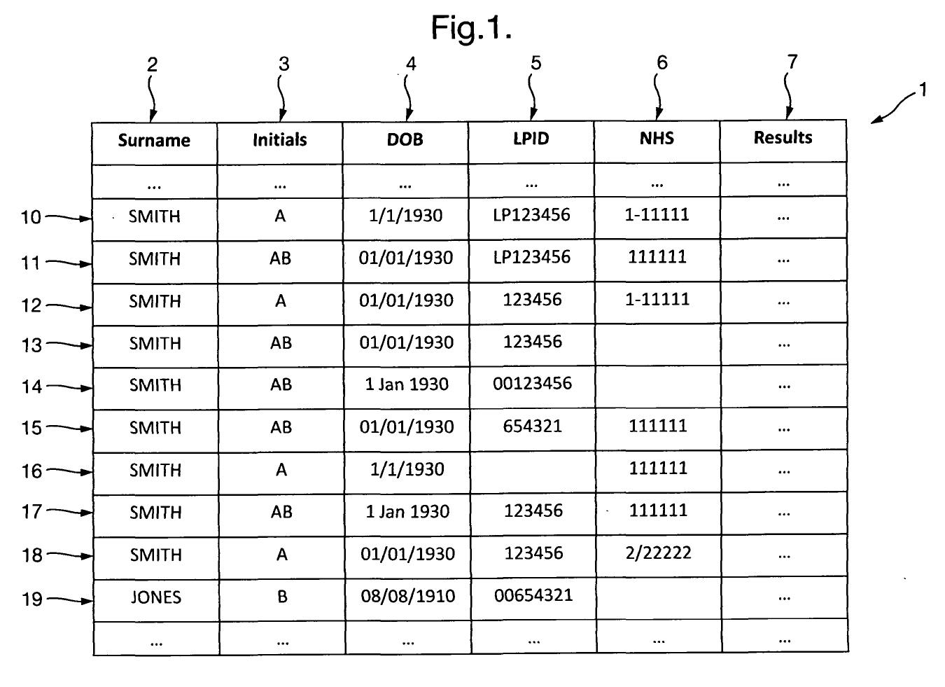

A method of linking records in a database in accordance with an embodiment of the present invention is now described with reference to FIGS. 1 to 6.

FIG. 1 shows an excerpt of an electronic database of healthcare records containing details of tests performed upon hospital patients. The database 1 has fields 2 to 6, which respectively contain data relating to the surname, initials, date of birth, LPID number (a number assigned by the hospital to the patient), and NHS number of the patient. Field 7 contains data relating to the results of the test (data not shown in FIG. 1 for clarity). In practice there would be further fields containing other data relevant to the test, such as the date of the test, the doctor who took the test, and so on.

The excerpt shows records 10 to 19 from the database 1. As can be seen, not all fields of the records contain data. For example, records 13 and 14 do not contain any

NHS number data in field 6. Also, the data stored in a particular field may not be in the same format. For example, record 10 has the NHS number in field 6 recorded as “1-11111”, while record 11 has the NHS number recorded as “111111” (in other words without any hyphen).

In a first step in the method, the data in the fields of records that relate to the identity of the patient are “cleaned”, by putting the data in each field in a canonical form. In the database 1, these fields are fields 1 to 6, in other words all fields other than the results field 7.

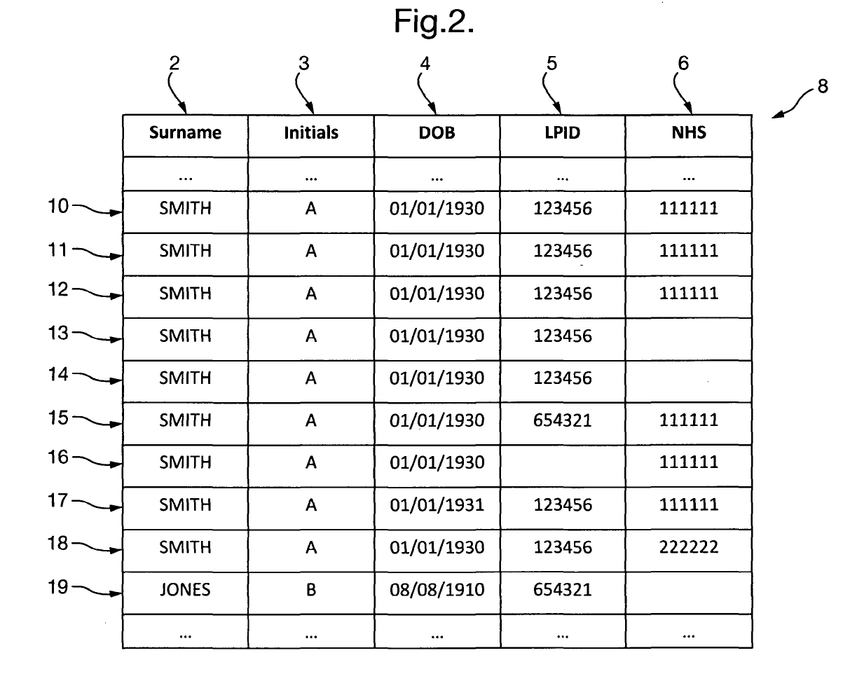

The cleaning of the data is as follows. For initials field 3, any initials after the first initial are discarded (so “AB” becomes “A”, for example). For date of birth field 4, all dates are put in the standard form DD/MM/YYYY. For LPID number field 5, any initial zeros or “LP” are discarded, so that each number is a simple six-figure numeral. For NHS number field 6, any hyphens or slashes are discarded, so again each number is a simple six-figure numeral. The results 8 of cleaning the data are shown in FIG. 2.

In an advantageous embodiment where the database contains both surname and forename data, in a further step the surname and forename data is analysed to identify any inversions. (By “inversions” is meant the surname being recorded as the forename and vice versa). This is done using a list of forenames and surnames and their frequencies of occurrence, obtained for example from an electoral roll or NHS master database. Using this list, a probabilistic model is used to estimate the probability that the surname and forename have been inverted in a particular record. If the probability exceeds a pre-determined threshold, the surname and forename are inverted.

Next, for each record a combination of “identifiers” are obtained from the data contained in the fields of the record. An identifier is a piece of data that should uniquely identify a patient. For example, an LPID number should only be assigned to a single patient, and so this number taken alone can be considered to be an identifier. Similarly, an NHS number can be considered to be an identifier. However, a surname taken alone is unlikely to identify a patient uniquely (as many people may have the same surname), but a surname in conjunction with first initial and date of birth may well be expected to uniquely identify a patient, and in the present example this combination is taken to be an identifier. The identifiers in the present example are therefore as follows:

First identifier: surname (field 2), initial (field 3) and date of birth (field 4) taken together

Second identifier: LPID number (field 5) taken alone

Third identifier: NHS number (field 6) taken alone

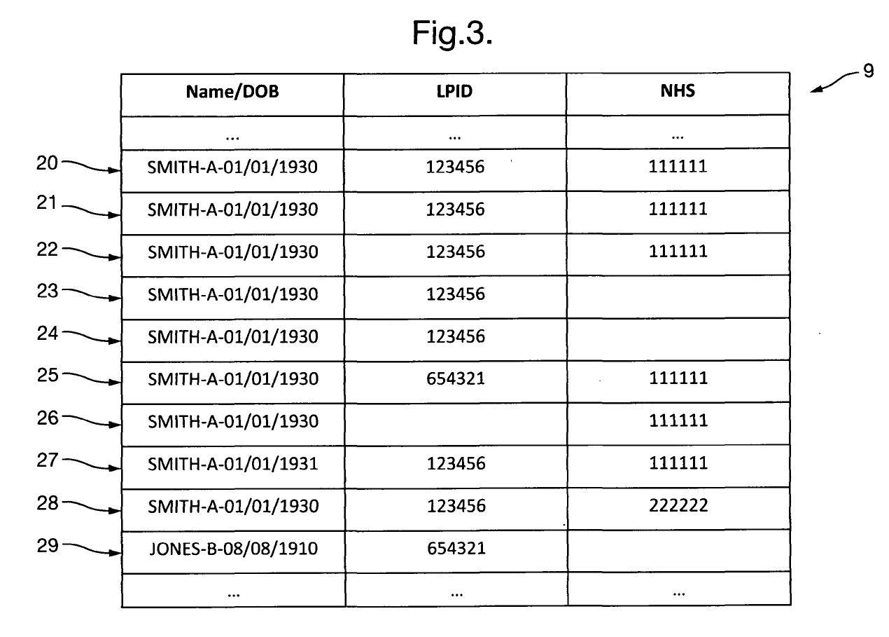

The set combinations of identifiers 9 for the database 1, in particular the combinations of identifiers 20 to 29 for the records 10 to 19 respectively, are shown in FIG. 3.

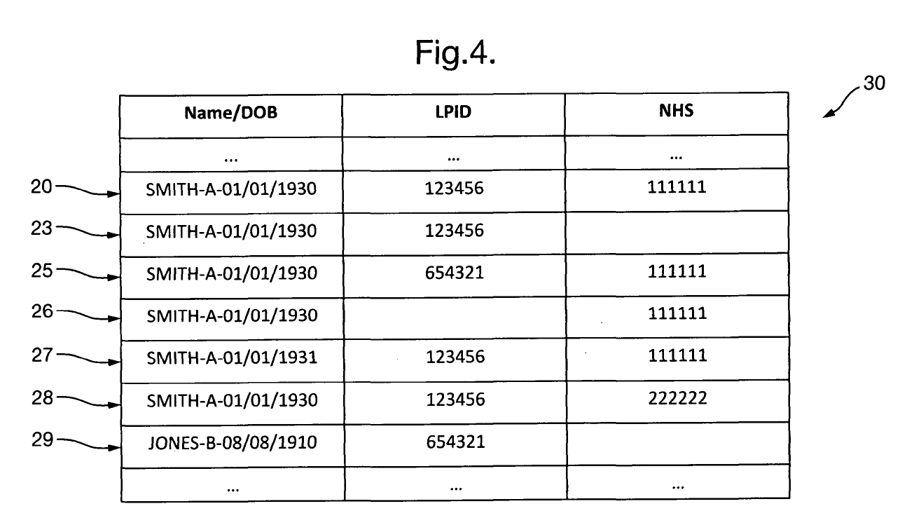

Next, the unique combinations of identifiers are obtained from the set of combinations of identifiers 9, by discarding any duplicates. In the present example, this means that the duplicates 21 and 22 of combination of identifiers 20 are discarded, as is the duplicate 24 of combination of identifiers 23. The set of unique combinations of identifiers 30 obtained from the set of combinations of identifiers 9 is shown in FIG. 4.

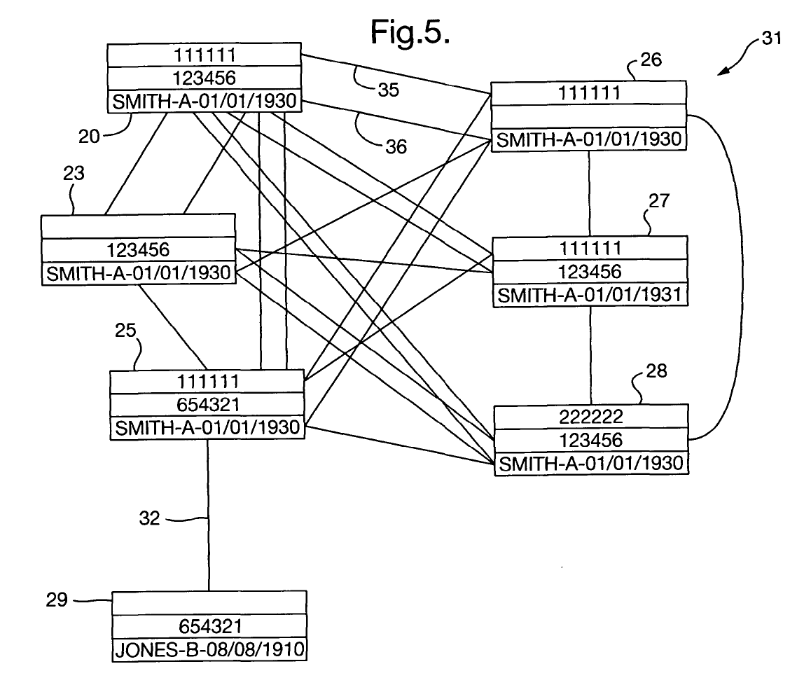

As shown in FIG. 5, the unique combinations of identifiers then are considered as nodes in a graph. Edges between the nodes are created whenever the combinations share an identifier (unless the identifier is blank). As can be seen from FIG. 5, this means that for example combination 20 shares two edges with combination 26, as they share the identifier “111111” (based on the LPID number from the underlying records) and identifier “SMITH-A-01/01/1930” (based on the surname, initial and date of birth from the underlying record). Similarly, combinations 25 and 26 share a single edge as they share the identifier “654321” (again based on the LPID number from the underlying records). Various suitable join algorithms to partition the set of unique combinations 30 into clusters will be well known to the skilled person (see for example Schaeffer SE 2007, Computer Science Review 1: 27-64)

As can be seen from FIG. 5, the combinations 20, 23 and 25 to 29 form a cluster 31 of joined combinations due to shared identifiers between the combinations, and the rest of the unique combinations from the set of unique combinations 20 will form into a number of other clusters (not shown).

Next, a quality value for each cluster is obtained. Various quality statistics can be used to provide the quality values, but overall, the quality value gives a measure of how well the combinations in the cluster are connected to each other. In particular, it should determine the likelihood that a cluster is derived from one, or more than one, individual.

The construction of a quality statistic to classify clusters in accordance with an embodiment of the invention is now described.

Initially, a test data set including test clusters of known status is required. This can be obtained, for example, by manual inspection of a small portion of the dataset. For each test cluster, each identifier is compared against all other identifiers of the same type, using a distance measure. For example, the LPID number identifier “123456” of combination 20 is compared against all other LPID number identifiers in the same cluster. Various suitable distance measures will be known to the skilled person, for example the Levenshtien edit distance, Jaro-Winkler string similarity function, a count of distinct identifiers, or some other function (see for example Cohen W W, Ravikumar P, Fienberg S E; A comparison of string metrics for name matching tasks. Proceedings of the International Joint Conferences on Artificial Intelligence 2003 pp 73-78). The same distance measure is applied to the NHS number and other identifiers. Thus, a matrix of pairwise distances can be constructed.

Using the matrices obtained from the clusters (or a simplification of the matrices, such as the maximum distance between identifiers within a cluster), along with the known statuses of the test clusters, the quality statistic for classifying clusters can be constructed.

The principles behind generation of such a classifier are well known to those skilled in the art (see for example the Naïve Bayes' approach described in Fellegi, I. P., and Sunter, A. B. (1969), “A Theory for Record Linkage,” Journal of the American Statistical Association, 64, 1183-1210). Alternative methods for constructing the quality statistic might include use of logistic regression modelling using the maximum distance between LPID numbers, NHS numbers, and other identifiers, neural networks, principal components analysis, support vector machines, or many other supervised learning techniques.

The quality statistic thus constructed from the test clusters is then used to provide a quality value for the other clusters, which is used as follows. If the quality value for a cluster is above a pre-determined threshold, the cluster is not considered any further.

However, if the quality value is below the pre-determined threshold, the cluster is further analysed. In summary, for each cluster, there will usually be a number of different identifiers (and their connected edges) which can be deleted, and whose deletion yields two clusters. The results of each of these deletions are assessed, and an optimum solution found, after one or more than one deletion step. In detail, the steps are as follows:
a) A catalogue is made of all k identifiers (and the edges to which they are attached).
b) k temporary copies of the cluster are made. From each of the k copies, one identifier (and any edges to which the identifier attaches) is deleted.

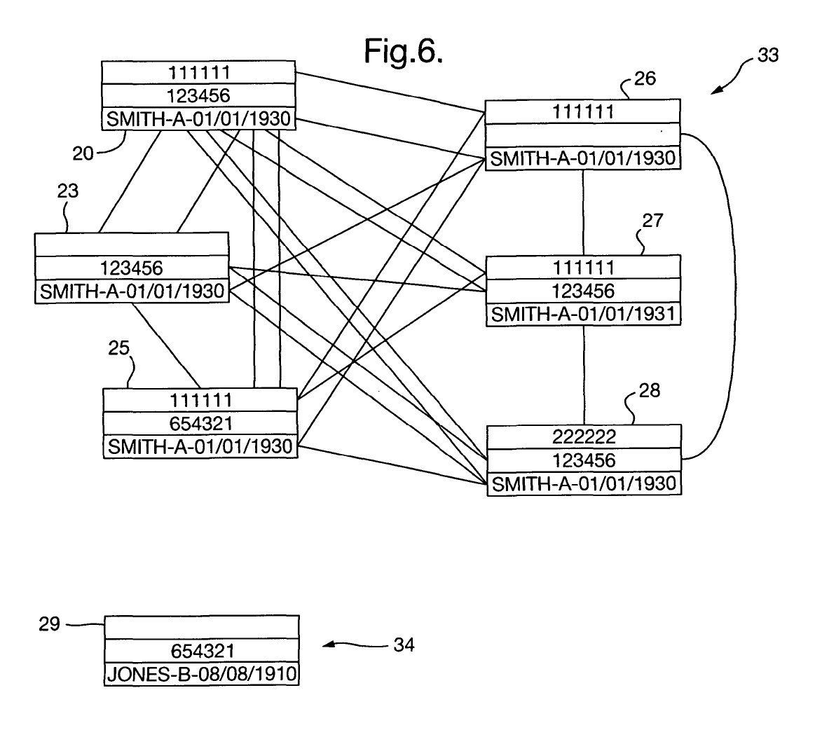

c) It is determined whether the deletion which has been made splits the cluster into two separate clusters. Suppose that l of the k possible solutions to the clusters splitting problem split into exactly two clusters. This would occur, for example, if identifier “654321” of combination 25 of FIG. 5 were deleted, resulting in edge 32 being deleted and the cluster 31 splitting into the two clusters 33 and 34 as shown in FIG. 6. Cluster 33 consists of combinations 20, 23 and 25 to 28, and cluster 34 consists of the single combination 29 only.

d) The scores associated with the l successfully split clusters are compared against a pre-determined criterion. Suppose m of the l deletions results in a ‘good’ solution, that is all the resulting clusters exceeding a pre-defined quality threshold.

e) If m=1, then a solution has been found and operations on that cluster cease.

f) If m>1, then optionally the m solutions can be compared using additional information (such as frequencies of error rates in different identifiers, frequencies of occurrence of different combinations in different datasets) to assess which identifier is most likely to be inaccurate. However, in the absence of such information additional inference may not be possible, and either one of the m solutions is chosen at random, or all have to be presented as possible solutions to the end user.

g) If m=0, and neither cluster generated from the split has a quality score exceeding the threshold, the process stops.

h) If m=0 and one of the generated clusters has a quality score exceeding threshold, then the other cluster (which has a score below threshold) can be re-analysed using the above process (starting at step b) until a solution is found; alternative solutions will have to be evaluated as described in steps g and h.

It will be appreciated that using the above procedure, two combinations linked by two or more edges can never be split (as only one edge is deleted at a time). In an alternative embodiment, instead of temporarily deleting only a single edge, any edges between two combinations are temporarily deleted. For example, both edge 35 and edge 36 between combination 20 and 26 may be deleted. The resulting cluster or clusters are then analysed as in the original embodiment, and the process repeated as required until no further improvements in quality are possible. In another alternative embodiment, multiple edges in a cluster may be temporarily deleted, according to some pre-determined rule. (Two or few edges may be temporarily deleted, for example.) This would for example allow a cluster of three combinations, each linked to the other by a single link (so forming a triangle), to be considered as separate clusters, which is not possible using the above procedure.

The result of the above procedure will be a set of clusters of combinations. The records underlying the combinations in a cluster are considered to be associated with the same patient. The final step of the method is therefore to link any records that underlie combinations in the same cluster.

In the present example, assume the result of the procedure on the cluster 31 was the set of clusters shown in FIG. 6, cluster 33 and cluster 34. (In other words, clusters 33 and 34 which resulted from the deletion of edge 32 had a higher quality values than cluster 31, but no other deletions of edges resulted in improved quality values.) The result of the procedure in this case is then that records 10 to 18 that underlie the combinations 20, 23 and 25 to 28 are associated with a single patient with the following details:

Surname: SMITH

Initial: A

Date of birth: Jan. 1, 1930 or Jan. 1, 1931

LPID number: 123456 or 654321

NHS number: 111111 or 666666

Similarly, record 19 that underlies the combination 29 is associated with a single, distinct patient with the following details:

Surname: JONES

Initial: B

Date of birth: Aug. 8, 1910

LPID number: 654321

NHS number: unknown

Note that errors in data in the records mean that there may (and most likely will) be multiple possible values for the various pieces of information about a patient. For example, the first patient's date of birth may be Jan. 1, 1930 or Jan. 1, 1931. As an observation, it can be seen that the correct value is most likely Jan. 1, 1930. Similarly, the first patient's LPID number may be 123456 or 654321. As an observation, it can be seen that the correct value is most likely 123456. Further, the erroneous link to the combination 29 resulted from the value 654321 being incorrectly contained in record 15, this being the value for the second patient as contained in record 19, the record underlying the combination 29.

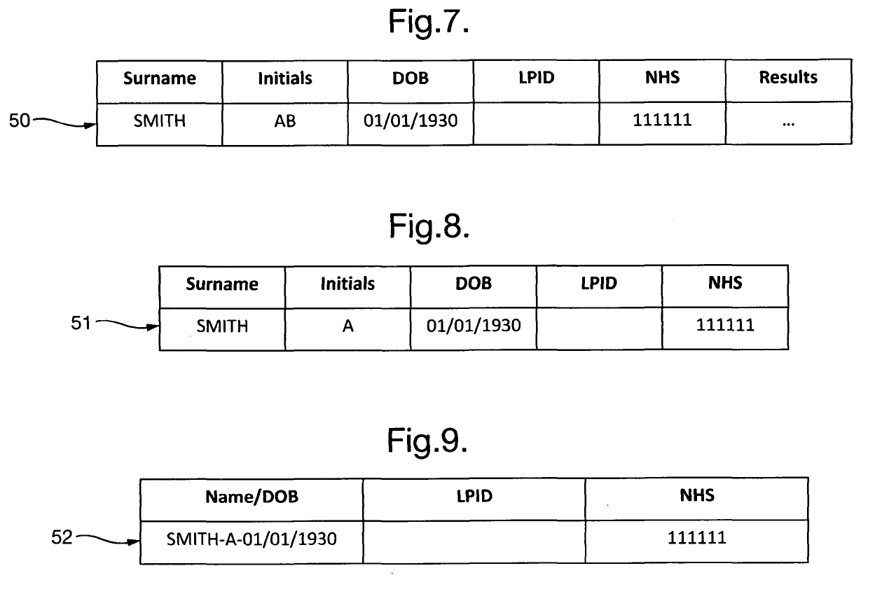

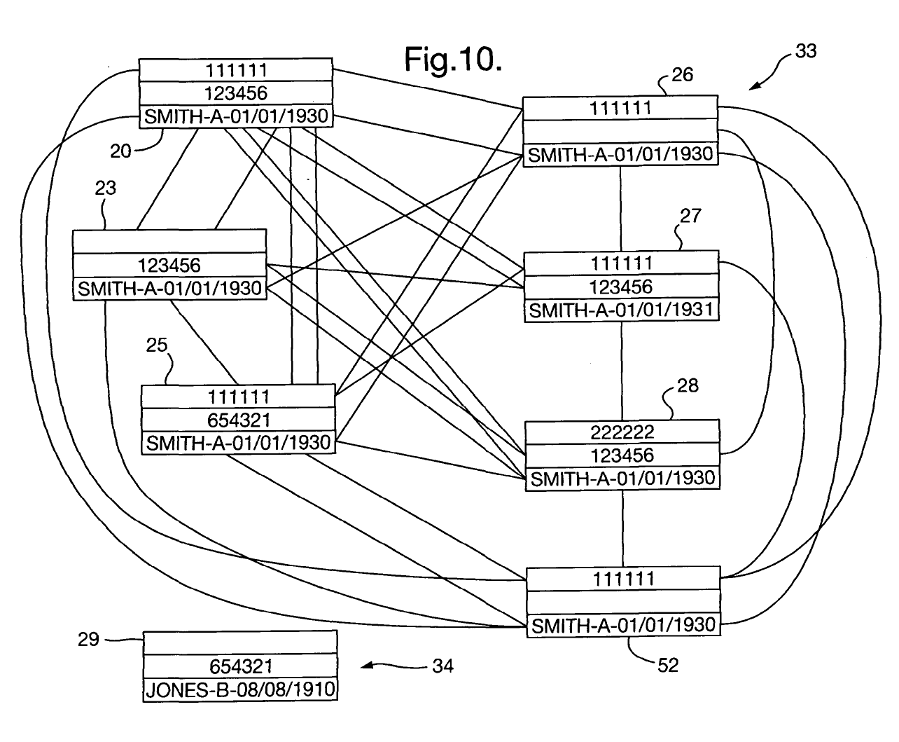

A method of linking a new record to records that have previously been linked with a method in accordance with the previous embodiment of the present invention is now described, with reference to FIGS. 7 to 9.

In the present example, a new record 50 as shown in FIG. 7 is to be added to the records of the database of FIG. 1, which have been linked as described above. As the existing records have been linked, the set of clusters as shown in FIG. 6 is available for use in the method of the present embodiment.

Similarly to the previous embodiment, the new record 50 is first cleaned to produce the record 51 shown in FIG. 8, and the cleaned record is used to obtain the new combination of identifiers 52 as shown in FIG. 9.

The new combination 52 is then compared to the set of combinations obtained for the existing records. If the new combination 52 is already present in that set of combinations, then the new record is simply linked to the existing records underlying that combination, and to any existing records underlying a combination in the same cluster as that combination. The method is then finished.

If the new combination 52 is not present in that set of combinations, then the method is as follows. First, an edge is created between the new combination 52 and any existing combinations that share an identifier (combinations 20, 23, 25, 27, 27 and 28 in the present example). The new combination 52 may be joined to an existing cluster (as happens in the present example, where the new combination 52 is joined to cluster 33), or may join one or more existing clusters together.

Similarly to the previous embodiment, a quality value for the cluster containing the new combination 52 is obtained. Again similarly to the previous embodiment, if the quality value is below the threshold, the cluster is analysed to see if it can be split into two or more clusters of a higher quality value than the original cluster, and the process is repeated until no further increase in quality values is possible.

The final step of the method is then to link the new record 50 underlying the new combination 52 to any records underlying combinations in the same cluster as the combination 52.

A method of identifying data that is likely to contain errors, in electronic database records that have previously been linked with a method in accordance with either of the previous embodiment of the present invention, is now described.

It will be appreciated that, when linking records using the methods of the previous embodiments, clusters are split in the case that the resulting clusters have a higher quality value than the original cluster. A higher quality value is indicates that a cluster is more likely to contain only records associated with a single member, and so this indicates that a removed link will have linked equal identifiers in records that were in fact associated with different members. As the identifiers are intended to uniquely identify the members, this suggests that the data from at least one of the records that underlay the identifiers must contain errors. As a consequence, by noting which links were removed, and the identifiers which caused them to be created, the data underlying those identifiers can be identified as data that is likely to contain errors.

Whilst the present invention has been described and illustrated with reference to particular embodiments, it will be appreciated by those of ordinary skill in the art that the invention lends itself to many different variations not specifically illustrated herein.

1. A method of linking electronic database records, wherein each record is associated with a single member from a set of unique members, and wherein each member from the set of unique members has associated with it a plurality of identifiers for uniquely identifying the member, the method comprising the steps of:
1) obtaining a set of combinations of identifiers by, for each record, determining a plurality of identifiers using the data stored in the record;
2) creating a set of clusters of linked combinations of identifiers, by creating a link between any combinations that have equal identifiers;
3) for each cluster from the set of clusters, calculating a quality value for the cluster;
4) for any cluster whose quality value is below a pre-determined threshold, splitting the cluster into two or more clusters by removing one or more links between combinations in the original cluster, in the case that the resulting clusters have higher quality values than the original cluster;
5) linking any records whose corresponding combinations of identifiers are members of the same cluster.

2. A method as claimed in claim 1, further comprising the following step performed before step 1:
0a) putting the data in the records in a canonical form.

3. A method as claimed in claim 1, further comprising the following step performed before step 1:
0b) determining, from the fields of the database records, the categories of identifiers to be used to uniquely identify the members from the set of unique members.

4. A method as claimed in claim 1, wherein step 1 further comprises the substep:
1a) obtaining a set of unique combinations of identifiers by removing any duplicates from the set of combinations obtained from the records.

5. A method as claimed in claim 1, wherein step comprises the following substeps:
3a) calculating a similarity value for corresponding identifiers from pairs of combinations in the cluster;
3b) using the similarly values for each identifier to calculate the quality value for the cluster.

6. A method as claimed in claim 1, wherein step 3 comprises the following substeps:
3a) calculating a similarity value for corresponding fields from pairs of records from which the combinations in the cluster were obtained;
3b) using the similarly values for each field to calculate the quality value for the cluster.

7. A method as claimed in claim 1, wherein in step 4 a cluster is split into two clusters by removing an identifier from one of the combinations of identifiers and any links created due to that identifier.

8. A method as claimed in claim 1, wherein in step 4 a cluster is split into two clusters by removing any links between two combinations in the original cluster.

9. A method as claimed in claim 1, wherein steps 3 and 4 are repeatedly performed on any resulting clusters until all remaining clusters have a quality value below the pre-determined threshold.

10. A method as claimed in claim 1, wherein the database records are obtained from two or more separate electronic databases.

11. A method of linking a new electronic database record to existing records linked by a method as claimed in claim 1, comprising the steps of:
1) obtaining the combination of identifiers for the new record;
2) creating a link between the new combination and any combinations that have equal identifiers from the set of clusters created when linking the existing records;
3) calculating a quality value for the cluster containing the new combination;
4) if the quality value of the cluster is below the pre-determined threshold, splitting the cluster into two or more clusters by removing one or more links between combinations in the original cluster, in the case that the resulting clusters have higher quality values than the original cluster;
5) linking the new record to any record whose corresponding combination of identifiers is a member of the same cluster as the new combination.

12. A method as claimed in claim 11, further comprising the following step performed before step 1:
0a) putting the data in the new record in a canonical form.

13. A method as claimed in claim 11, wherein in step 4 a cluster is split into two clusters by removing an identifier from one of the combinations of identifiers and any links created due to that identifier.

14. A method as claimed in claim 11, wherein steps 3 and 4 are repeatedly performed on any resulting clusters until all remaining clusters have quality value below the pre-determined threshold.

15. A method as claim in claim 11, further comprising the following steps performed after step 1:
1a) if the new combination is already present in the set of combinations of identifiers obtained when linking the existing records, linking the new record to any record whose corresponding combination of identifiers is a member of the same cluster as the new combination, and not performing any of the remaining steps.

16. A method of identifying data that is likely to contain errors, in electronic database records linked by a method as claimed in claim 1, comprising the steps of:
1) for any cluster split into two or more clusters by removing one or more links, determining the identifiers linked by the removed links;
2) determining the data of the records underlying the identifiers determined in step 1;
wherein the identified data is the data determined in step 2.

17. A computer program product arranged, when executed, to perform the steps of a method as claimed in claim 1.

18. A method of identifying data that is likely to contain errors, in electronic database records linked by a method as claimed in claim 11, comprising the steps of:
1) for any cluster split into two or more clusters by removing one or more links, determining the identifiers linked by the removed links;
2) determining the data of the records underlying the identifiers determined in step 1;
wherein the identified data is the data determined in step 2.
